(19) United States
(12) Patent Application Publication
(10) Pub. No.: US 2025/0145462 A1
(43) Pub. Date: May 8, 2025

(54) HIGH-ENTROPY OXIDES

(71) Applicant: Auckland UniServices Limited, Auckland (NZ)

(72) Inventors: Peng Cao, Auckland (NZ); Yuguang Pu, Shenzhen (CN)

(73) Assignee: Auckland UniServices Limited, Auckland (NZ)

(21) Appl. No.: 18/837,301

(22) PCT Filed: Feb. 9, 2023
(86) PCT No.: PCT/NZ2023/050008

§ 371 Date: Aug. 9, 2024

(30) Foreign Application Priority Data
Feb. 9, 2022 (WO) PCT/CN2022/075610
Sep. 6, 2022 (NZ) 792122

(51) Int. Cl. C01B 13/36

(52) U.S. Cl. CPC C01B 13/363; C01P 2002/01; C01P 2002/72; C01P 2002/88; C01P 2004/03; C01P 2004/04; C01P 2006/40

(57) ABSTRACT

Disclosed are high-entropy oxides, and methods of their preparation. The high-entropy oxide is characterised by a sub-micron particle size and rod-like particle shape. The method of its preparation includes a co-precipitation step, preferably using an oxalate compound as a precipitating agent. Also disclosed are an electrode, e.g. an anode, a catalyst and an electrochemical cell comprising the high-entropy oxide.

### BACKGROUND

### Field

The present disclosure relates to high-entropy oxides, method for the preparation thereof and the use thereof as an electrode material and a catalyst.

### Description of Related Art

High-entropy oxides, also known as entropy stabilised oxides, have drawn much attention for their outstanding compositional and structural stability under extreme conditions, such as extreme temperatures and chemical environments. Furthermore, many other appealing and unique properties have been discovered in these materials, such as exceptional superionic conductivity at room temperature, high dielectric constant, and tailorable bandgap. As such, high-entropy oxides may be useful as anode materials (e.g. in lithium batteries), cathode materials, and catalysts.

Solid-state synthesis is the most common and facile method to fabricate high-entropy oxides. For example, Qiu et al. (Qiu, N.; Chen, H.; Yang, Z.; Sun, S.; Wang, Y.; Cui, Y., “A high entropy oxide (Mg_{0.2}Co_{0.2}Ni_{0.2}Cu_{0.2}Zn_{0.2}O) with superior lithium storage performance” Journal of Alloys and Compounds 2019, 777, 767-774) describes a method in which MgO, CoO, NiO, CuO and ZnO were mixed in a planetary ball mill, then pressed into pellets and sintered at 1000° C. for 24 hours. However, the particles synthesised by solid state methods are often large, which adversely impacts the applications of entropy stabilised oxides. For example, large particles tend to slow down catalytic reaction rates due to the limited specific surface area of catalysts. A recently developed variation of the solid-state method used nebulised spray pyrolysis to synthesise (Mg_{0.2}Co_{0.2}Ni_{0.2}Cu_{0.2}Zn_{0.2})O (Sarkar, A.; Velasco, L.; Wang, D.; Wang, Q.; Talasila, G.; de Biasi, L.; Kubel, C.; Brezesinski, T.; Bhattacharya, S. S.; Hahn, H., “High entropy oxides for reversible energy storage” Nature communications 2018, 9 (1), 1-9). The entropy stabilised oxide particles synthesised by this method were found to be either hollow or solid spheres, and the particle size ranged from nanometre to micrometre. Such a broad size distribution may lead to a high overpotential on large particles when the particles are used as electrode materials.

Alternatively, co-precipitation methods may be used to synthesise nanosized high-entropy oxides. These methods generally involve transforming metal cations into a hydroxide precursor and then annealing the precursor to provide an oxide product. Sodium hydroxide and ammonia solution are commonly used to prepare the hydroxide precursors. However, many practical issues arise from these methods. For instance, as sodium hydroxide and ammonia solution react with metal cations rapidly, it is difficult to regulate the shape and size distribution of the synthesised particles. Hexamethylenetetramine (HMTA) or urea are sometimes used as precipitants for homogeneous deposition in addition to direct hydroxide sources such as NaOH. In these cases, the functional component for precipitation is ammonia generated by the thermal decomposition of the precipitants, which subsequently dissolves into water to generate ammonium hydroxide. The low basicity when stoichiometric ammonia is added leads to incomplete deposition of Mg²⁺. On the other hand, excessive addition of urea or HMTA would cause re-dissolution of as-precipitated Cu(OH)₂ by forming copper-ammonia complexes. After co-precipitation, the obtained precursor usually undergoes a subsequent annealing process at elevated temperatures. Such annealing leads to severe agglomeration of ultrafine high-entropy oxide particles. Consequently, it is still challenging to synthesise high-entropy oxides with a narrow size distribution and a homogeneous composition of the submicron particles.

### Object

Accordingly, it is an object of the present invention to go some way to avoiding the above disadvantages; and/or to at least provide the public with a useful choice.

Other objects of the invention may become apparent from the following description which is given by way of example only.

### BRIEF SUMMARY

### Definitions

“Annealing process” and “solid solution process” means a thermal treatment of a material to allow some degree of atomic migration in order to reduce structural defects of the material.

“Calcining process” means a thermal treatment of a material in which the organic components of a material are removed, for example, by oxidation or gasification.

“High-entropy oxide” means an oxide material characterized by the presence of four or more elementally different metal cations within the ionic structure.

Oxide materials comprising four elementally different metal cations may be referred to in the art as “medium entropy oxides”. For the avoidance of doubt, in this application the term “high-entropy oxide” encompasses an oxide material characterized by the presence of four or more elementally different metal cations within the ionic structure.

The four or more elementally different metal cations are preferably present in substantially equimolar amounts in a high-entropy oxide, although this is not essential.

For example, each metal cation may make up at least 5% of the total number of the four or more elementally different metal cations in the high-entropy oxide.

“Metal cation” includes cations of metal elements in Groups 2 (alkali earth metals), and Groups 3-12 (transition metals).

“Particle shape” means the shape of a particle. Particle shapes include spheres, rods, cubes and plates.

“Particle size D₅₀” means the median particle size of a sample.

“Particle size D₉₀” means the particle size of the 90th percentile of a sample.

In a first aspect, the present invention is directed to a method of preparing a high-entropy oxide, the method comprising:
a. providing at least four metal salts;
b. mixing the metal salts in a solvent to form a solution;
c. mixing the solution obtained in step (b) with a precipitating agent to obtain a precipitate;
d. thermally treating the precipitate of step (c) to obtain a high-entropy oxide.

In some embodiments, the thermal treatment step (d) comprises heating the precipitate for a period of at least about 30 minutes. In some embodiments, the thermal treatment comprises heating the precipitate for a period of about 1 hour, about 2 hours, about 3 hours, about 4 hours, about 5 hours, about 6 hours, about 7 hours, or about 8 hours.

In some embodiments, the thermal treatment of step (d) includes a calcining process. In some embodiments, the calcining process performed at a temperature of about 300° C. to about 1200° C. In some embodiments, the calcining process is performed at a temperature of about 350° C. to about 450° C. In some embodiments, the calcining process is performed at a temperature of about 400° C. In some embodiments the calcining process is performed at a temperature of about 900 to about 1100° C. In some embodiments the calcining process is performed at a temperature of about 1000° C.

In some embodiments, the thermal treatment step (d) includes a calcining process to provide an oxide intermediate. In some embodiments the calcining process comprises heating the precipitate for a period of about 2 hours to about 4 hours, at a temperature of about 300° C. to about 500° C. to form an oxide intermediate.

In some embodiments, the thermal treatment step (d) includes an annealing process. In some embodiments, the annealing process comprises heating an oxide intermediate for a period of about 3 hours to about 6 hours, at a temperature of about 900° C. to about 1100° C. In some embodiments, the annealing process comprises heading the oxide intermediate for a period of at least 5 hours.

In some embodiments, the thermal treatment step (d) includes an annealing process performed immediately after a calcining process, e.g. in the same apparatus without isolating the oxide intermediate. In some embodiments, the oxide intermediate is cooled (e.g., to room temperature) before annealing process.

In some embodiments, the thermal treatment step (d) includes a combined calcining and annealing process, comprising heating the precipitate for a period of about 3 hours to about 6 hours, at a temperature of about 900° C. to about 1100° C.

In some embodiments, an oxide intermediate is mixed with a solid-state dispersant before annealing. In some of these embodiments, the oxide intermediate is suspended in a solvent (e.g., water) with the solid-state dispersant, then the suspension is dried and the resulting powder ground before annealing.

In some embodiments, the amount of the solid-state dispersant is greater than about 5 times (by weight) the amount of the oxide intermediate. In some embodiments, the amount of the solid-state dispersant is greater than about 10 times (by weight) the amount of the oxide intermediate. In some embodiments, the amount of the solid-state dispersant is about 5 to about 15 times (by weight) the amount of the oxide intermediate. In some embodiments, the amount of the solid-state dispersant is about 10 times (by weight) the amount of the oxide intermediate.

In some embodiments, the solid-state dispersant is a material having a melting point above the annealing temperature. In some embodiments, the solid-state dispersant is water soluble. In some embodiments, the solid-state dispersant is inert.

Preferably, the solid-state dispersant is selected from the group consisting of potassium sulfate, potassium phosphate, sodium phosphate, sodium aluminate and a combination of any two or more thereof. In some embodiments, the solid-state dispersant is potassium sulfate.

In some embodiments, the method further comprises washing the product obtained from the annealing process with a solid-state dispersant with water to remove the solid-state dispersant.

In some embodiments the solid-state dispersant is selected from the group consisting of potassium sulfate, potassium phosphate, sodium phosphate, sodium aluminate and a combination of any two or more thereof. In some embodiments, the solid-state dispersant is potassium sulfate.

In some embodiments, the thermal treatment step (d) includes the use of a controlled atmosphere. In some embodiments, the controlled atmosphere includes oxygen.

In some embodiments, four metal salts are provided in step (a). In some embodiments five metal salts are provided. In some embodiments six or more metal salts are provided.

In some embodiments, the metal salts are selected from the group consisting of salts of Be, Mg, Ca, Sr, Ba, Mn, Fe, Co, Ni, Cu, Zn, Gd, Pb, and Pt. In some embodiments, the metal salts are each independently selected from a chloride salt, a nitrate salt, a sulfate salt or an acetate salt.

In some embodiments the metal salts are salts of Mg, Ni, Cu, Co, and Zn. In some embodiments, the Mg salt, the Co salt, the Ni salt, and the Cu salt are each independently selected from a chloride salt, a nitrate salt, a sulfate salt or an acetate salt. In some embodiments, the Mg salt, the Co salt, the Ni salt, and the Cu salt are chloride salts. In some embodiments, the Zn salt is a nitrate salt, a sulfate salt or an acetate salt. In some embodiments, the Zn salt is a nitrate salt.

In some embodiments the metal salts are salts of Mg, Mn, Fe, Co, and Ni. In some embodiments, the Mg salt, the Co salt, the Ni salt, and the Cu salt are each independently selected from a chloride salt, a nitrate salt, a sulfate salt or an acetate salt. In some embodiments, the Mg, Mn, Fe, Co and Ni salts are chloride salts.

In some embodiments, the precipitating agent is a hydroxide compound (e.g. NaOH), an organic compound (e.g. an oxalate compound) or a source of ammonia (e.g. hexamethylenetetramine or urea). A preferred precipitating agent is an oxalate compound. In some embodiments, the oxalate compound is soluble in a solution of water and ethylene glycol, for example, in a solution of 1:2 water:ethylene glycol solution (by volume). In some embodiments, the oxalate compound is ammonium oxalate. In some embodiments, the oxalate compound is ammonium oxalate monohydrate.

In some embodiments, the solvent used in step (b) to form a solution of the metal salts is water, such as deionised water; water and organic solvent; or organic solvent. A preferred solvent includes water and ethylene glycol. In some embodiments, the solvent includes a mixture of water and ethylene glycol, wherein the water and ethylene glycol are in a ratio within the range of from 1.5:2 to 0.5:2 (by volume). In some embodiments, the solvent includes water and ethylene glycol in a ratio of about 1:2 (by volume).

The four or more elementally different metal cations are preferably present in substantially equimolar amounts, although this is not essential. In some embodiments, the quantity of each of the metal cations is at least about 5% of the total quantity of metal cations. Each metal cation may make up at least 10%, at least 15%, at least 20%, or at least 25% of the total number of metal cations in the high-entropy oxide. Each metal cation in the high-entropy oxide may make up between 5% and 30% of the total number of metal cations in the high-entropy oxide. For example, each metal cation in the high-entropy oxide may make up between 10% and 30%, or between 15% and 30%, or between 20% and 30%, of the total number of metal cations.

In some embodiments, the precipitating agent is dissolved in a solvent before mixing with the solution obtained in step (b). In some embodiments, the solvent used to dissolve the precipitating agent is water. In some embodiments, the solvent includes a mixture of water and an organic solvent, such as ethylene glycol. In some embodiments, the solvent includes a mixture of water and ethylene glycol, wherein the water and ethylene glycol are in a ratio within the range of from 1.5:2 to 0.5:2 (by volume). In some embodiments, the solvent includes water and ethylene glycol in a ratio of about 1:2 (by volume).

In some embodiments, the precipitate in step (c) is obtained in solvent that includes water, such as deionised water; water and organic solvent; or organic solvent.

In some embodiments, the solvent includes a mixture of water and ethylene glycol, the mixture being in a ratio within the range of from 1.5:2 to 0.5:2 (by volume). In some embodiments, the solvent includes water and ethylene glycol in a ratio of about 1:2 (by volume).

In some embodiments, the high-entropy oxide has an entropy stabilised crystalline structure.

In another aspect, the present invention is directed to a high-entropy oxide prepared by the method of the invention.

In another aspect, the present invention is directed to a method of controlling dispersity of a particle size of a high-entropy oxide, wherein using the above method of preparing a high-entropy oxide, the thermal treatment of step (d) is performed at controlled temperatures and/or times to produce a desired particle size dispersity.

In another aspect, the present invention provides a high-entropy oxide represented by the formula (AᵥB_{w}CₓD_{y}E_{z})O, wherein v, w, x, y and z are each independently about 0.05 to about 0.30, provided that v+w+x+y+z=1; each of A, B, C, D and E is a different element selected from the list consisting of Be, Mg, Ca, Sr, Ba, Mn, Fe, Co, Ni, Cu, Zn, Gd, Pb, and Pt; and wherein the high-entropy oxide is characterised by any one or more of the following:
a X-ray powder diffraction spectrum comprising (111) and (200) peaks wherein the relative peak intensity of I₍₁₁₁₎/I₍₂₀₀₎ is greater than about 1;
an average particle size D₅₀ of about 800 nm or less;
a particle size D₉₀ of about 1200 nm or less;
submicron particles having a rod-like shape;
a particle size distribution having a standard deviation of less than about 250 nm.

In some embodiments, v, w, x, y and z are each about 0.2.

In some embodiments the high-entropy oxide is represented by the formula (MgᵥCo_{w}NiₓCu_{y}Zn_{z})O, or the formula (MgᵥMn_{w}FeₓCo_{y}Ni_{z})O.

In some embodiments, the relative peak intensity of I₍₁₁₁₎/I₍₂₀₀₎ is about 1.2 to about 2.0, about 1.3 to about 1.9, about 1.4 to about 1.8, or about 1.5 to about 1.7.

Preferably, the relative peak intensity of I₍₁₁₁₎/I₍₂₀₀₎ is about 1.6.

In some embodiments, the high-entropy oxide is characterised by a X-ray powder diffraction spectrum comprising (111), (200) and (220) peaks. In some embodiments, the relative peak intensity of I₍₂₂₀₎/I₍₂₀₀₎ is about 0.3 to about 1.1, about 0.4 to about 1.0, about 0.5 to about 0.9, or about 0.6 to about 0.8. Preferably, the relative peak intensity of I₍₂₀₎/I₍₂₀₀₎ is 0.7.

In some embodiments, the high-entropy oxide is characterised by a X-ray powder diffraction spectrum comprising (111), (200), (220), (311) and (222) peaks. In some embodiments, the relative peak intensity of I₍₃₁₁₎/I₍₂₂₂₎ is less than about 1.

In some embodiments, the high-entropy oxide is characterised by an X-ray powder diffraction spectrum substantially as shown in FIG. 5.

In some embodiments, the high-entropy oxide is characterised as having a substantially uniform particle size distribution.

In some embodiments, the high-entropy oxide has a particle size distribution having a standard deviation of less than about 245 nm, less than about 240 nm, less than about 235 nm, less than about 230 nm, less than about 225 nm, less than about 220 nm, less than about 215 nm, less than about 210 nm, less than about 205 nm, or less than about 200 nm. In some embodiments, the high-entropy oxide has a particle size distribution having a standard deviation of about 215 nm and a relative standard deviation of about 0.34.

In some embodiments, the high-entropy oxide is characterised by an average particle size D₅₀ of about 700 nm or less. In some embodiments, the high-entropy oxide is characterised by an average particle size D₅₀ of about 600 nm or less. In some embodiments, the high-entropy oxide is characterised by an average particle size D₅₀ of about 600 nm. In some embodiments, the high-entropy oxide is characterised by a particle size D₉₀ of about 1100 nm or less. In some embodiments, the high-entropy oxide is characterised by a particle size D₉₀ of about 1000 nm or less. In some embodiments, the high-entropy oxide is characterised by a particle size D₉₀ of about 1000 nm.

In some embodiments, the length:width ratio of the submicron particles having a rod-like shape is about 1:1.5 to about 1:3.5. In some embodiments, the length:width ratio of the submicron particles is about 1:2 to about 1:3. In some embodiments, the length:width ratio of the submicron particles is about 1:2.5. In some embodiments, the average length of the submicron particles is about 400 nm to about 1000 nm. In some embodiments, the average length of the submicron particles is about 500 nm to about 900 nm. In some embodiments, the average length of the submicron particles is about 630 nm. In some embodiments, the average width of the submicron particles is about 150 nm to about 450 nm, about 200 nm to about 400 nm or about 250 nm to about 350 nm. In some embodiments, the average width of the submicron particles is about 300 nm.

In some embodiments, the high-entropy oxide is substantially non-porous. In some embodiments, the high-entropy oxide is non-porous.

In some embodiments, the high-entropy oxide is substantially homogeneous.

In some embodiments, the high-entropy oxide is a single phase.

In some embodiments, the high-entropy oxide has a lattice parameter of at least about 4 Å, preferably between about 4.0 Å to about 4.4 Å, more preferably about 4.1 Å to about 4.3 Å. In some embodiments, the lattice parameter is about 4.24 Å, preferably the lattice parameter is 4.2395 Å.

In still another aspect, the present invention is directed to an electrode, e.g. an anode or a cathode, comprising a high-entropy oxide according to the invention.

In some embodiments, the electrode comprises at least about 70% (by weight) of the high-entropy oxide. In some embodiments, the electrode comprises at least about 80% (by weight) of the high-entropy oxide. In some embodiments, the electrode comprises about 80% (by weight) of the high-entropy oxide.

In some embodiments, the electrode is an anode. In some embodiments, the anode further comprises a conductive additive, such as carbon black (e.g. Super P carbon black), acetylene black, conductive graphite, Ketjen black™, carbon nanotubes or a combination of any two or more thereof. In some embodiments, the anode comprises about 5% to about 15% (by weight) of the conductive additive. In some embodiments, the anode comprises about 10% (by weight) of the conductive additive. In some embodiments, the anode further comprises a binder, such as polyvinylidene fluoride (PVDF) carboxymethyl cellulose (CMC) or a combination thereof. In some embodiments, the anode comprises about 5% to about 15% (by weight) of the binder. In some embodiments, the anode comprises about 10% (by weight) of the binder. In some embodiments, the anode further comprises another anode material.

In some embodiments, the anode has a specific capacity of at least about 600 mAh/g. In some embodiments, the anode has a specific capacity of about 600 mAh/g to about 1200 mAh/g. In some embodiments, the anode has a specific capacity of at least about 700 mAh/g, about 800 mAh/g, about 900 mAh/g, about 100 mAh/g, about 1100 mAh/g or about 1200 mAh/g. In some embodiments, the anode has a specific capacity of about 800 mAh/g at a current rate of 0.2 Å/g. In some embodiments, the anode has a specific capacity of at least about 800 mAh/g after 400 cycles. In some embodiments, the anode has a specific capacity of at least about 900 mAh/g after 400 cycles. In some embodiments, the anode has a specific capacity of at least about 1000 mAh/g after 400 cycles. In some embodiments, the anode has a specific capacity of at least about 1100 mAh/g after 400 cycles. In some embodiments, the anode has a specific capacity of at least about 800 mAh/g after 470 cycles. In some embodiments, the anode has a specific capacity of at least about 900 mAh/g after 470 cycles. In some embodiments, the anode has a specific capacity of at least about 1000 mAh/g after 470 cycles. In some embodiments, the anode has a specific capacity of at least about 1100 mAh/g after 470 cycles.

In yet another aspect, the present invention is directed to a catalyst comprising the high-entropy oxide according to the invention. In some embodiments, the catalyst is useful for catalysing a reaction selected from the group consisting of water-gas-shift, steam-reforming, Fischer-Tropsch synthesis or higher alcohol synthesis from CO₂ reduction

In a further aspect, the present invention is directed to an electrochemical cell comprising, an anode, a cathode, a separator between the anode and cathode, and an electrolyte, wherein the anode comprises the high-entropy oxide according to the invention.

In some embodiments, the electrochemical cell is comprised in a lithium-ion battery.

In a further aspect, there is provided a high-entropy oxide comprising four or more elementally different metal cations, each metal cation making up at least 5% of the total number of the four or more elementally different metal cations in the high-entropy oxide, wherein the high-entropy oxide comprises a rod-like particle shape.

The high-entropy oxide may include five elementally different metal cations.

Each metal cation in the high-entropy oxide may make up at least 10%, at least 15%, at least 20%, or at least 25% of the total number of metal cations in the high-entropy oxide. Each metal cation in the high-entropy oxide may make up between 5% and 30% of the total number of metal cations in the high-entropy oxide.

Each metal cation may be present in substantially equimolar amounts.

Each metal cation may be independently selected from the group consisting of cations of Be, Mg, Ca, Sr, Ba, Mn, Fe, Co, Ni, Cu, Zn, Gd, Pb and Pt.

The high-entropy oxide may be characterised by one or more of the following: a particle size D50 of about 800 nm or less; and a particle size D90 of about 1200 nm or less.

The high-entropy oxide may be characterised by a particle size distribution having a standard deviation of less than about 250 nm.

The high-entropy oxide may include oxides represented by the formula (MgᵥCo_{w}NiₓCu_{y}Zn_{z})O or (MgᵥMn_{w}FeₓCo_{y}Ni_{z})O, where v, w, x, y and z are between 0.05 and 0.30. In some embodiments, v, w, x, y and z may each be between 0.05 and 0.30, between 0.1 and 0.3, between 0.15 and 0.25, or about 0.2.

The high-entropy oxide may be characterised by a X-ray powder diffraction spectrum includes (111) and (200) peaks where the relative peak intensity of I₍₁₁₁₎/I₍₂₀₀₎ is greater than about 1.

The high-entropy oxide may be characterised by a X-ray powder diffraction spectrum includes (111), (200) and (220) peaks and the relative peak intensity of I₍₂₂₀₎/I₍₂₀₀₎ is about 0.3 to about 1.1.

The high-entropy oxide may be characterised by a X-ray powder diffraction spectrum includes (111), (200), (220), (311) and (222) peaks and the relative peak intensity of I₍₃₁₁₎/I₍₂₂₂₎ is less than about 1.

The length:width ratio of the submicron particles of the high-entropy oxide may be between about 1:1.5 and about 1:3.5.

In a further aspect, there is provided a method of preparing a high-entropy oxide, the method including (a) mixing a solution comprising at least four elementally different metal cations in a solvent, each metal cation making up at least 5% of the total number of the four or more elementally different metal cations, with a precipitating agent to obtain a solid material comprising the at least four metal cations, and (b) thermally treating the solid material to obtain a high-entropy oxide; where the precipitating agent includes an organic anion.

The thermal treatment may include a calcining process to produce a high-entropy oxide intermediate.

The thermal treatment may also include the use of a controlled atmosphere.

The controlled atmosphere includes a controlled amount of oxygen.

The method may include annealing the high-entropy oxide intermediate to obtain the high-entropy oxide.

The method may include mixing the high-entropy oxide intermediate with a solid-state dispersant before annealing.

The high-entropy oxide may be quenched following annealing. The high-entropy oxide may be quenched by rapidly cooling the high-entropy oxide immediately following the annealing process. Rapid cooling may be achieved by removing the high-entropy oxide from the oven and allowing to cool by exposure to ambient (e.g., room temperature) air. Rapid cooling may also be achieved by contacting the high-entropy oxide with cooled fluids such as cooled air or liquid nitrogen.

The solution may comprise at least five elementally different metal cations.

Each metal cation may be independently selected from the group consisting of cations of Be, Mg, Ca, Sr, Ba, Mn, Fe, Co, Ni, Cu, Zn, Gd, Pb and Pt. For example, each metal cation may be independently selected from the group consisting of cations of Mg, Co, Ni, Cu and Zn, or independently selected from the group consisting of cations of Mg, Mn, Fe, Co and Ni.

The precipitating agent may comprise an oxalate anion. For example, the precipitating agent may comprise ammonium oxalate.

The solvent may include water, a combination of water and organic solvent, or organic solvent. The solvent may include water and ethylene glycol, such as water and ethylene glycol in a ratio within the range of from 1.5:2 to 0.5:2 (by volume).

In a further aspect, there is provided a method of preparing a high-entropy oxide, the method comprising:
a. mixing a solution comprising at least four elementally different metal cations in a solvent, each metal cation making up at least 5% of the total number of the four or more elementally different metal cations, with a precipitating agent to obtain a solid material comprising the at least four metal cations;
b. thermally treating the solid material to obtain a high-entropy oxide intermediate;
c. mixing the high-entropy oxide intermediate with a solid-state dispersant and annealing the high-entropy oxide intermediate to form the high-entropy oxide.

In a further aspect there is provided an oxalate salt comprising four or more elementally different metal cations, each metal cation making up at least 5% of the total number of metal cations.

The oxalate salt may comprise or consist essentially of particles that each comprise the four or more elementally different metal cations.

Each metal cation may be independently selected from the group consisting of cations of Be, Mg, Ca, Sr, Ba, Mn, Fe, Co, Ni, Cu, Zn, Gd, Pb and Pt. For example, each metal cation may be independently selected from the group consisting of cations of Mg, Co, Ni, Cu and Zn, or independently selected from the group consisting of cations of Mg, Mn, Fe, Co and Ni.

The oxalate salt may be a solid material having a submicron particle size. The oxalate salt may have a rod-like shape. For example, the length:width ratio of oxalate salt particles may be between about 1:1.5 to about 1:3.5.

The oxalate salt may be represented by the formula (AᵥB_{w}CₓD_{y}E_{z})C₂O₄, where v, w, x, y and z are each independently about 0.05 to about 0.30, and where A, B, C, D, and E are each independently selected from the group consisting of cations of Be, Mg, Ca, Sr, Ba, Mn, Fe, Co, Ni, Cu, Zn, Gd, Pb and Pt. In some embodiments, v, w, x, y and z may each be between 0.05 and 0.30, between 0.1 and 0.3, between 0.15 and 0.25, or about 0.2.

In a further aspect, there is provided a method of preparing the oxalate salt described above, comprising a step of combining a first solution comprising four or more elementally different metal cations, each metal cation making up at least 5% of the total number of metal cations in solution, with a stoichiometrically equivalent amount of oxalate anions.

The four or more elementally different metal cations may be present in each oxalate salt particle in their stoichiometric proportion.

In a further aspect, there is provided a high-entropy oxide having the formula (MgᵥMn_{w}FeₓCo_{y}Ni_{z})O, where v, w, x, y and z may each be between 0.05 and 0.30, between 0.1 and 0.3, between 0.15 and 0.25, or about 0.2.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

In addition, where features or aspects of the invention are described in terms of Markush groups, those persons skilled in the art will appreciate that the invention is also thereby described in terms of any individual member or subgroup of members of the Markush group.

As used herein “(s)” following a noun means the plural and/or singular forms of the noun.

As used herein the term “and/or” means “and” or “or” or both.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Although the present invention is broadly as defined above, those persons skilled in the art will appreciate that the invention is not limited thereto and that the invention also includes embodiments of which the following description gives examples.

Further aspects, novel features and advantages of the present disclosure will be readily apparent to those skilled in the art in light any one or more of the illustrative embodiments set out in the detailed description and drawings. The description and drawings are to be regarded as illustrative in nature, and not restrictive. Modifications or improvements may be made without departing from the spirit or scope of the disclosure and claims.

### BRIEF DESCRIPTION OF THE SEVERAL VIEWS OF THE DRAWINGS

A number of example embodiments will now be described by way of example with reference to the accompanying drawings, in which:

FIG. 1 shows (a) a SEM image of as-precipitated oxalate precursor described in Example 1, and (b) a TEM bright-field image of a few oxalate precursor bundles described in Example 1.

FIG. 2 shows a) a high-angle annular dark-field scanning transmission electron microscopic (HAADF-STEM) image of an oxalate bundle described in Example 1 with a scale bar of 200 nm, and (b)-(f) show EDS elemental mappings of Cu, Co, Ni, Zn, and Mg, respectively.

FIG. 3 shows a thermogravimetric analysis (TGA), and differential scanning calorimetry (DSC) and derivative thermogravimetry (DTG, dotted line) plots of an oxalate precursor described in Example 1.

FIG. 4 shows XRD patterns of the high-entropy oxides annealed from room temperature to different terminal temperatures and then held at each temperature for 3 hours, as described in Example 2. From bottom to top: 700° C., 800° C., 900° C. and 1000° C. Square, asterisk, triangle, and hash indicate rocksalt, tenorite (CuO), spinel (CO₃O₄), wurtzite (ZnO) phases, respectively.

FIG. 5 shows an XRD pattern of the high-entropy oxide (Mg_{0.2}Co_{0.2}Ni_{0.2}Cu_{0.2}Zn_{0.2})O prepared via solid-state dispersant assisted annealing. The projections of different crystal planes are exhibited next to their corresponding diffraction peaks.

FIG. 6 shows a Rietveld refinement of corresponding XRD patterns.

FIG. 7 shows (a) a SEM image of high-entropy oxide rods, (b) a bright-field TEM image of high-entropy oxide rods, and (c) high-resolution TEM image of a high-entropy oxide rod showing rocksalt lattice fringes of (111) planes parallel to the longitudinal axis of the rod, while the top-left corner inset is the corresponding FFT patterns.

FIG. 8 shows (a-c) a HAADF-STEM image, an ABF image, and a contrast-reversed image of the ABF image taken along [100] orientation (metal cations and oxygen anions are depicted as large and small spheres, respectively), and (d) ABF image taken along [110] orientation (drifts of 0 atomic columns are demonstrated as arrows, and the direction of an arrow indicates the drifting orientation).

FIG. 9 shows (a) the CV curves in the first 5 cycles, (b) the CV curves at crescent scan rates from 0.3 mV/s to 1.0 mV/s, and (c) the voltage profiles in different cycles at a current rate of 0.2 Å/g.

FIG. 10 shows the cycling performance of a high-entropy oxide anode in 470 cycles at 0.2 A/g.

FIG. 11 shows (a) the rate performance, (b) the voltage profiles at different current rates, and (c) the cycling performance of conventionally annealed (CA) high-entropy oxide anode at 0.1-A/g.

FIG. 12 shows the first discharge profiles of the high-entropy oxide anode prepared by conventional annealing (dashed) and dispersant assisted annealing (solid) at a current rate of 0.1 A/g, and inset image is the differential capacity plots (dQ/dV) of two discharge profiles.

FIG. 13 shows XRD patterns of (a) a product annealed without external oxygen, (b) a product annealed with excessive oxygen, (c) a product annealed with external oxygen and insufficient annealing time, (d) a product of sufficient annealing and external oxygen, according to Example 6.

FIG. 14 shows an SEM image of as-precipitated oxalate precursor described in Example 5.

FIG. 15 shows oxidation states of Mn, Fe, Co and Ni in the high-entropy oxide of Example 6, investigated by X-ray absorption near edge structure (XANES).

FIG. 16 illustrates an aspect of the subject matter in accordance with one embodiment.

FIG. 17 shows a) a high-angle annular dark-field scanning transmission electron microscopic (HAADF-STEM) image (scale bar of 100 nm), and (b)-(f) show EDS elemental mappings of Mg (b), Mn (c), Fe (d), Co (e) and Ni (f), for the high-entropy oxide particle described in Example 6.

FIG. 18 shows a schematic of a half cell described in Example 3.

FIG. 19 shows a schematic of a coin cell described in Example 4.

### DETAILED DESCRIPTION

### Examples

### Characterization Methods

The composition of the samples was determined by ICP emission spectroscopy (ICP-OES Agilent 5110). About 10 mg of respective samples were dissolved in 10 ml aqua regia at 200° C. in a PTFE beaker. Analysis was undertaken using five different calibration solutions. The structures and phase purity of different samples were characterized by X-ray diffraction (X'Pert Pro MPD with Cu Kα radiation). The thermal analysis was performed on a simultaneous thermal analyzer (Netzsch STA 449° F.3 Jupiter) in a Pt crucible with a ramp rate of 5° C./min in flowing air. X-ray photoelectron spectroscopy measurements were performed on a Thermo Escalab 250 XI with a monochromatic Al Kα source and a spot size of 400 μm. All spectra were calibrated with the C 1s peak of adventitious hydrocarbons at 284.8 eV before fitting.

SEM images were taken on a field-emission scanning electron microscope (Thermo Fisher Scientific Apreo S) operating at 30 kV and 0.4 nA. Bright-field TEM images and EDS linear scanning results were obtained on a transmission electron microscope (FEI Tecnai F30) equipped with an XFlash 6T-60 EDS detector (Bruker). The atomic-scale characterizations of individual high-entropy oxide nanorods were conducted on an aberration-corrected S/TEM (FEI Titan Cubed Themis G2 300, FEI) at an accelerating voltage of 300 kV with a convergence semi-angle of 25 mrad. The scanning/TEM was equipped with a monochromator, an EDS detector (Bruker), a Gatan imaging filter (GIF Quantum ER/965, Gatan) of high-resolution electron energy loss spectrometer, and a high-speed K2 camera (Gatan). The multiple-inelastic-scattering background in the core-loss region was removed by Fourier ratio deconvolution of the low energy-loss signal. Line profiles were collected from EDS mappings of each element cation using Gatan DigitalMicrograph GMS3 software. The profiles were converted into text files via the script (Export Profile as Tabbed Text) created by Dave Mitchell, which is available on the website: www.dmscripting.com.

All chemicals were purchased from Sigma Aldrich and were used without further purification.

### Example 1a: Co-Precipitation of an Oxalate Precursor of (Mg_{0.2}Co_{0.2}Ni_{0.2}Cu_{0.2}Zn_{0.2})O High-Entropy Oxide

The preferred method for production of a precursor for forming a high-entropy oxide ((Mg_{0.2}Co_{0.2}Ni_{0.2}Cu_{0.2}Zn_{0.2})O) involved the use of oxalate anions to achieve near-equimolar deposition of elementally different cations by forming corresponding complexes in solution. Oxalate anions were found to form precipitating complexes with Mg, Co, Ni, Cu and Zn cations in polar and protic solutions. Oxalate anions were particularly preferred because they were found to have similar rates of precipitate formation for each metal cation, such that each precipitating particle comprised proportions of metal cations that were substantially equivalent with the proportion of metal cations in the reaction solution.

MgCl₂·6H₂O (99%, 0.55 mmol), CuCl₂·6H₂O (99%, 0.5 mmol), CoCl₂·6H₂O (99%, 0.5 mmol), NiCl₂·6H₂O (99.9%, 0.5 mmol), and Zn(NO₃)₂·6H₂O (98%, 0.5 mmol) were dissolved in a mixed solution of 10 ml deionized water and 20 ml ethylene glycol, marked as solution A. Zinc nitrate was preferred as a zinc source. Zinc chloride is less desirable as a zinc source because it forms insoluble zinc oxychloride in an aqueous solution. An excess of magnesium chloride was added because the magnesium oxalate precipitate is slightly soluble. Then, ammonium oxalate monohydrate ((NH₄)₂C₂O₄·H₂O, 99%, 2.55 mmol) was dissolved into another mixed solution of 10 ml deionized water and 20 ml ethylene glycol at 50° C., marked as solution B. Ammonium oxalate was the preferred precipitating agent because it is soluble in the water:ethylene glycol solvent.

The precipitation of the metal cations was less uniform when oxalic acid was used compared to oxalate salts (without being bound by theory, this is likely due to the acidity of oxalic acid affecting the relative solubility of the metal cations in solution). Group I counter ions such as sodium oxalate are insoluble in ethylene glycol and the oxalic acid may give rise to a dissolution of as-precipitated oxalates. Both solutions A and B were heated up to 50° C. under stirring. After that, solution B (oxalate ions) was rapidly poured into solution A (metal ions) under vigorous stirring. The suspension was further stirred at 50° C. for 8 hours, followed by separating the oxalate precursor from the reaction solution by centrifugation. The precursor was washed with water and absolute ethanol several times before drying at 70° C. overnight.

Without wishing to be bound by theory, the inventors believe the complex was formed in a step-wise polymerisation. The copper-oxalate complex was first formed, followed by forming the complexes of other three transition metals ions (that is, Ni²⁺, Zn²⁺, and Co²⁺). Due to a low value of the critical stability constant (log K), Mg²⁺ cations are most difficult to coordinate with oxalate ions. Therefore, the chains of the magnesium-oxalate complexes were formed last. This process provided a precipitated oxalate precursor having a rod-like shape and hierarchical bundle structure.

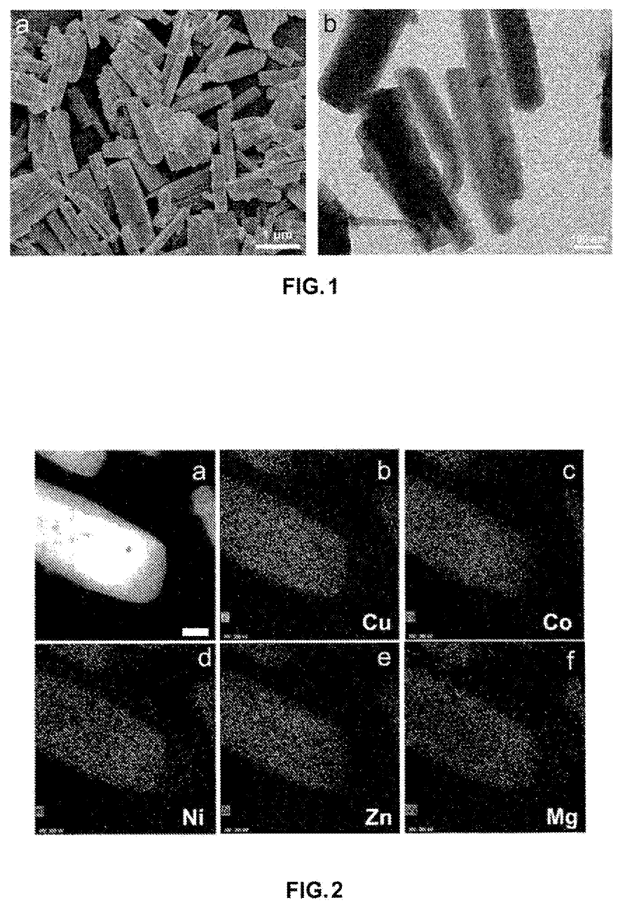

FIG. 1(a) illustrates a scanning electron microscopic (SEM) image of the as-prepared oxalate precursor. The precursor precipitated according to the process above showed bundle-like structure. The transmission electron microscopic (TEM) image in FIG. 1(b) demonstrates that the oxalate bundles were monodispersed. Each bundle was 500 nm to 1 μm long and with an average cross-section of 180×180 nm². The TEM image also revealed that the as-precipitated precursor was dense and solid.

Energy-dispersive X-ray spectroscopic (EDS) analysis was conducted on one of these bundles. The signal of Cu was more intense at the centre. In contrast, the Mg signal was relatively stronger on the periphery of the bundle. The signals of Ni, Zn, Co were almost uniform across the entire oxalate bundle. Hence, the results of the EDS analysis corroborated the above hypothesis on the hierarchical structure.

FIG. 2a shows a high-angle annular dark-field scanning transmission electron microscopic (HAADF-STEM) image of an oxalate bundle. In FIG. 2(b)-(f), the elemental mappings of Cu, Co, Ni, Zn, and Mg are displayed separately. At a glance, the overall distribution of 5 metal cations across the bundle suggests the successful co-precipitation of a multi-component system on a sub-micron scale. Additionally, a close-up observation indicates that the Mg concentration was more intensive on the periphery while those of Cu were denser at the core (see FIG. 2(b) and FIG. 2(f)).

The chemical composition of oxalate precursor was further determined by inductively coupled plasma optical emission spectrometry (ICP-OES). The results indicated that molar percentages of each metal cation are relatively close to 20%, i.e., they are close to equimolar.

### Example 1b: Alternative Anions

Several alternative anions were investigated for the preparation of high-entropy oxide precursor materials. These included hydroxide anions, formate anions, acetate anions, and citrate anions. The methodology of Example 1a was followed, except that oxalate was substituted for stoichiometric equivalents of sodium hydroxide, ammonium hydroxide, hexamethylenetetramine, formate, acetate, and citrate. Remarks on the suitability of these anions are provided in Table 1 below.

TABLE 1

| Precipitating | Functional | |
|---|---|---|
| agent | species | Remarks |
| NaOH | OH⁻ | Use of this precipitating agent |
| | | resulted in bulky hydroxide |
| | | precipitates of metal cations |
| NH₃•H₂O | NH₄OH | Use of these precipitating agents |
| | | resulted in incomplete |
| | | precipitation of Mg cations and/or |
| Hexamethylene- | | redissolution of Cu hydroxidate |
| tetramine (HMTA) | | precipitate by forming |
| | | tetra-ammine copper complex |
| Ammonium formate | HCOO— | Use of these precipitating agents |
| Ammonium acetate | CH₃COO— | resulted in the formation of |
| Lithium acetate | CH₃COO— | agglomerated floccules |
| Citric acid | C₆H₆O₇²⁻ | |
| Ammonium citrate | C₆H₆O₇²⁻ | |

### Example 2: Calcining and High Temperature Annealing of (Mg_{0.2}Co_{0.2}Ni_{0.2}Cu_{0.2}Zn_{0.2})O from Oxalate Precursor

To prepare an oxide intermediate, the dried oxalate precursor was calcined in a muffle furnace at 400° C. for 3 hours with a ramp rate of 10° C./min.

Two different annealing approaches were used to treat the calcined oxide intermediate to form a high-entropy oxide.

In a conventional approach, the oxide intermediate (as calcined, appearing as a black powder) was annealed in a muffle furnace at different temperatures for 3 hours. The temperatures used were 700° C., 800° C., 900° C. and 1000° C. The ramp rates of all processes were 10° C./min.

The second approach was an annealing process assisted by solid-state dispersants. 0.2 g oxide intermediate was re-dispersed in 40 ml deionized water with 2 g K₂SO₄ under stirring for 30 minutes. After being sonicated for 20 minutes, the suspension was put into an oven and heated up to 120° C. After the water was completely removed, the solid product was finely ground in a mortar. The powder was subsequently placed in ceramic crucibles and annealed at 1000° C. for 3 hours with the same ramp rate used previously. After annealing, K₂SO₄ was dissolved in water, while the solid product was separated out via vacuum filtration. Particles of the high-entropy oxide having a rod-like shape were obtained after washing the product with adequate deionized water and drying the sample in the oven.

The high-entropy oxide may be quenched following annealing. The high-entropy oxide may be quenched by rapidly cooling the high-entropy oxide immediately following the annealing process. Rapid cooling may be achieved by removing the high-entropy oxide from the oven and allowing to cool by exposure to ambient (e.g., room temperature) air. Rapid cooling may also be achieved by contacting the high-entropy oxide with cooled fluids such as cooled air or liquid nitrogen.

Superior particle size distributions and homogeneity, and superior electrochemical performance were obtained by an annealing process of at least 5 hours.

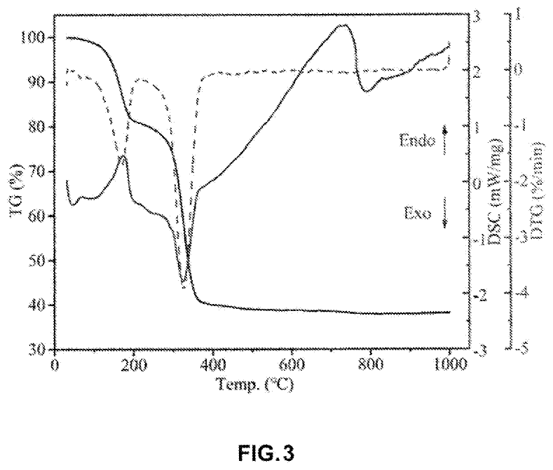

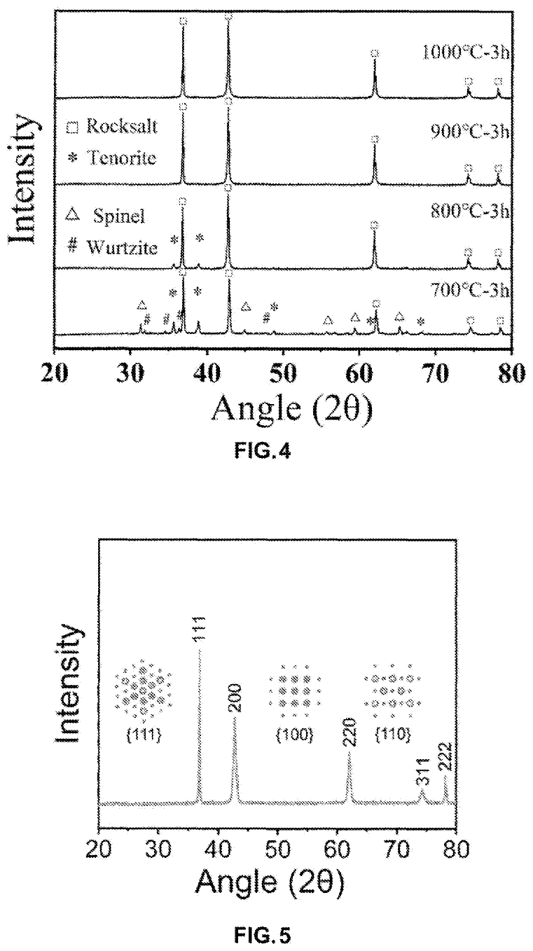

Thermogravimetric (TG) analysis of the high-entropy oxide in air from 30° C. to 1000° C. at a ramp rate of 5° C./min showed two notable weight-loss stages between 100° C. and 400° C. (FIG. 3). The weight loss at a lower temperature, represented by the inflexion point at 169° C. in derivative thermogravimetry (DTG), corresponds to water loss. The weight loss at a higher temperature corresponds to the decomposition of oxalate precursor, which is represented by the inflexion point at about 326° C. in DTG. At 1000° C., around 38% of the mass remains as the high-entropy product. Differential scanning calorimetry (DSC) further confirms that the water loss process is endothermic while the decomposition of oxalates is exothermic. Additionally, an enormous endothermic peak positioned at 740° C. is observed. This peak is indicative of the entropy-driven solid solution process, including the incorporation of Zn²⁺ into rocksalt structure and the conversion of spinel Co₃O₄ into CoO. It is believed that the mixing of various components on a sub-micron or even a nanometre scale in oxalate precursor facilitates the solid-solution process at a lower annealing temperature relative to known process. Furthermore, according to the X-ray diffraction (XRD) patterns in FIG. 4, the Bragg peaks indexed to tenorite CuO can be observed after heating the precursor at 800° C. for 3 hours. Those peaks disappear after further escalating the temperature to above 900° C., as tenorite CuO is gradually incorporated into the rocksalt structure, coinciding with the subtle endothermic peak in the DSC curve centred at 830° C.

Conventional annealing treatments at 1000° C. may lead to severe aggregation of particles. Therefore, to circumvent the formation of large aggregates, a solid-state dispersant was used during high-temperature annealing. Without wishing to be bound by theory, it is believed that the solid-state dispersant suppresses the aggregation and crystallite growth. Considering that the annealing temperature could be as high as 1000° C., potassium sulfate was selected as the dispersant since its melting point is 1069° C. Specifically, the oxalate precursor was first annealed at 400° C. for 3 hours to covert oxalates into a mixed-oxides intermediate. The phases in the intermediate are confirmed by XRD. Despite the poor crystallinity, the phases in the intermediate could be indexed to rocksalt NiO, tenorite CuO, rocksalt MgO, spinel Co₃O₄, and wurtzite ZnO. SEM and TEM images revealed that the bundle-like structure is preserved after moderate-temperature annealing. Interestingly, the intermediate rods have a mesoporous structure. This is because the thermal decomposition of oxalate precursor leaves substantial inner voids within these rods. The as-annealed intermediate was finely dispersed in K₂SO₄, followed by further annealing the mixture at 1000° C. for 3 hours.

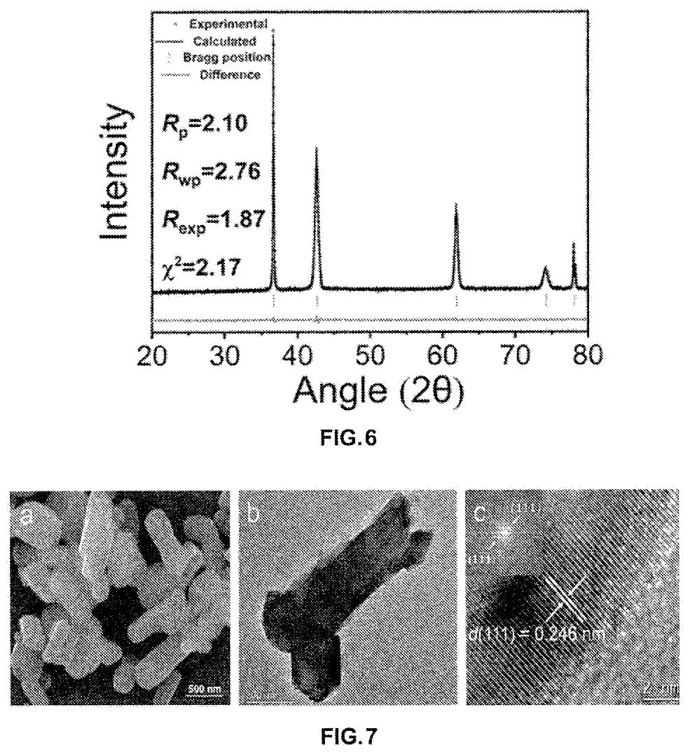

The XRD pattern in FIG. 5 demonstrates that the (Mg_{0.2}Co_{0.2}Ni_{0.2}Cu_{0.2}Zn_{0.2})O high-entropy oxide prepared via a solid-state dispersant assisted annealing is a single-phase compound without any impure phases. Peak positions are shown in Table 2, below. The Rietveld refinement results in FIG. 6 show good convergence and low R-factors, validating that the (Mg_{0.2}Co_{0.2}Ni_{0.2}Cu_{0.2}Zn_{0.2})O high-entropy oxide prepared via solid-state dispersant assisted annealing has an fcc cubic crystal structure with the Fm3□m space group. The refined lattice parameters are a=4.2395(3) Å, b=4.2395(3) Å, c=4.2395(3) Å, α=β=γ=90°, V=76.199(8) Å. In such a structure, oxygen anions occupy the 4a sites, whereas the octahedral 4b sites are randomly co-occupied by Co, Cu, Ni, Zn, and Mg ions with a coordination number of 6. This is a particular example of a high-entropy oxide that is an entropy stabilised oxide.

TABLE 2

| Peak positions | | | | | |
|---|---|---|---|---|---|
| (2θ) | (111) | (200) | (220) | (311) | (222) |
| (Mg_{0.2}Co_{0.2}Ni_{0.2}Cu_{0.2}Zn_{0.2})O | 36.8° | 42.7° | 62.0° | 74.3° | 78.2° |

FIG. 7(a) displays an SEM image of the as-annealed high-entropy oxide rods, validating that the uniformity and bundle-like structure of the oxalate precursor are preserved to a large extent after annealing. Unlike the porous intermediate, the high-entropy oxide nanorods were fairly dense, evidenced in the bright-field TEM image (FIG. 7(b)). As shown in FIG. 7(c), the high-resolution TEM image exhibits the (111) lattice fringes of the high-entropy oxide with an interplanar spacing of 0.246 nm. The axial (longitudinal) direction of the nanosized rod is along [111]. The corresponding Fast Fourier Transform (FFT) patterns are represented in the top-left corner. The EDS linear scanning across the width of a high-entropy oxide rod showed the distribution of 5 cations in high-entropy oxide become more uniform across the rod when compared with the linear scanning results for the oxalate precursor.

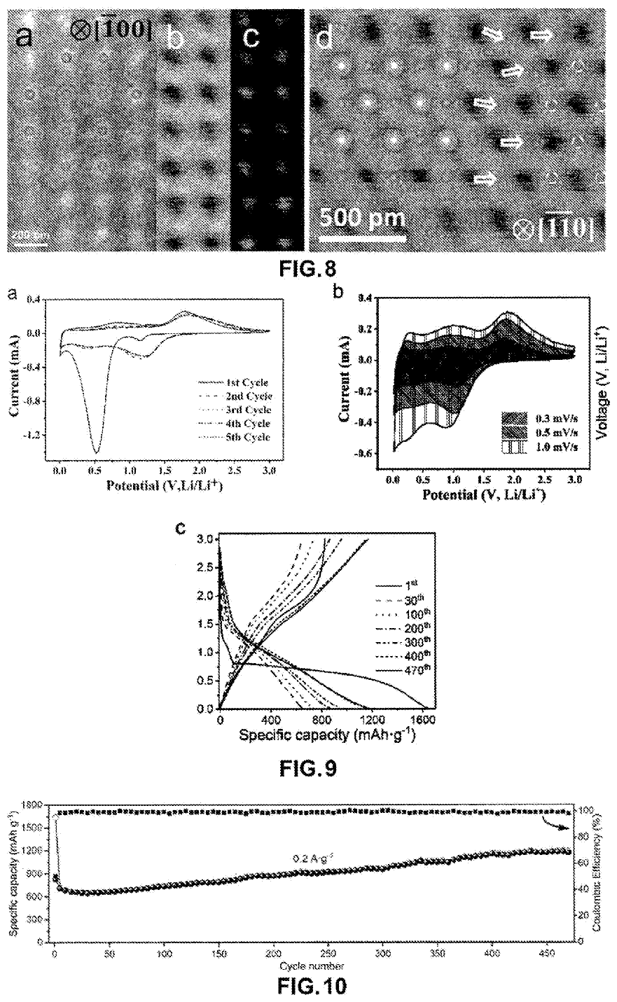

FIG. 8(a) shows the atomic-resolution HAADF-STEM image of a high-entropy oxide nanorod projected along the [100] orientation. The image explicitly reveals that the high-entropy oxide has an fcc sublattice of metal cations with oxygen anions residing at the octahedral holes, indicated by four large spheres (Me) and 12 small spheres (O). FIG. 8(b) shows an annular bright-field (ABF) image, indicating that the atomic columns of metals are axis-aligned with O atomic columns along [100] orientation. The ABF image along [110] direction (FIG. 8(d)) shows that some O anions exhibit a subtle drift from their perfect octahedral sites. This drift is believed to arise from the anion sublattice distortion caused by the Jahn-Teller effects on tetrahedrally coordinated Cu²⁺ in an octahedral configuration.

### Example 3: Electrochemical Performance of (Mg_{0.2}Co_{0.2}Ni_{0.2}Cu_{0.2}Zn_{0.2})O High-Entropy Oxide

The obtained high-entropy oxides were used to assemble electrochemical half cells, where lithium discs were employed as both counter and reference electrodes.

FIG. 18 shows a schematic of a half cell in the form of a coin cell 1816, comprising a top cap 1802, high-entropy oxide working electrode (anode layer 1804), a polymer separator 1806, a counter electrode (lithium disc 1808), a stainless steel spacer 1810, an o-ring 1812 and a bottom cap 1814.

The anode layer 1804 was prepared via a typical slurry method. The high-entropy oxide powder synthesised according to Example 2 was mixed with carbon black and PVDF binder to form a slurry with a mass ratio of 8:1:1 in N-methyl-2-pyrrolidinone (NMP). The obtained slurry was coated onto a copper foil. Then, the film was heated on a hotplate at 80° C. to evaporate the NMP, followed by completely drying the film under vacuum at 80° C. overnight. CR2032 coin cells were assembled in a glove box under a pure argon atmosphere. In the coin cell 2-electrode configuration shown in FIG. 18, lithium disc 1808 was separated from the anode layer 1804 by the polymer separator 1806. The electrolyte (not shown) was 1 M LiPF₆ dissolved in a mixture of ethylene carbonate (EC) and diethyl carbonate (DEC) with a volume ratio of 1:1. The mass loading of the active materials on the anode layer 1804 was 0.924-1.052 mg/cm².

FIG. 9(a) presents the cyclic voltammetry (CV) curves of the cell at a scan rate of 0.1 mV·s⁻¹. The curves are similar to those of the previously reported high-entropy oxides (Sarkar et al.). The intensive cathodic peak at 0.52 V is reduced remarkably after first cycling, indicating solid electrolyte interphase (SEI) formation and initial reduction of transition metal oxides into metals and Li₂O. A subtle cathodic peak at about 1.2 V in the first lithiation can be attributed to the Cu²⁺/Cu⁺ transformation. In the following cycles, four redox peaks are detectable from the CV results. One pair of intensive redox peaks centred at 1.2 V (cathodic) and 1.8 V (anodic) can be ascribed to the reduction of transition metal oxides and re-oxidation of metals. Additionally, a pair of minor redox peaks positioned at 0.375 V and 0.80 V may stem from a combined effect of the alloying and dealloying processes of Zn metal with Li and the spin-polarised surface capacitance of Co and Ni nanoparticles.

In the previous studies (Sarkar et al. and Ghigna, P.; Airoldi, L.; Fracchia, M.; Callegari, D.; Anselmi-Tamburini, U.; D'Angelo, P.; Pianta, N.; Ruffo, R.; Cibin, G.; de Souza, D. O.; Quartarone, E., Lithiation Mechanism in High-Entropy Oxides as Anode Materials for Li-Ion Batteries: An Operando XAS Study. ACS Applied Materials & Interfaces 2020, 12 (45), 50344-50354), multiple additional cathodic peaks were commonly observed in the first lithiation process, suggesting multiple individual lithiation reactions of the involved cations. The multiple cathodic peaks imply that known high-entropy oxide materials may still preserve a small amount of binary or ternary oxides at some microdomains. The CV curves for subsequent cycles are almost identical after 2 cycles, indicating a superior capacity retention ability of the high-entropy oxide electrodes. Moreover, the CV curves at increasing scan rates from 0.3 to 1 mV·s⁻¹ show similar redox trends in FIG. 9(b), which demonstrates a good electrochemical response to different current rates.

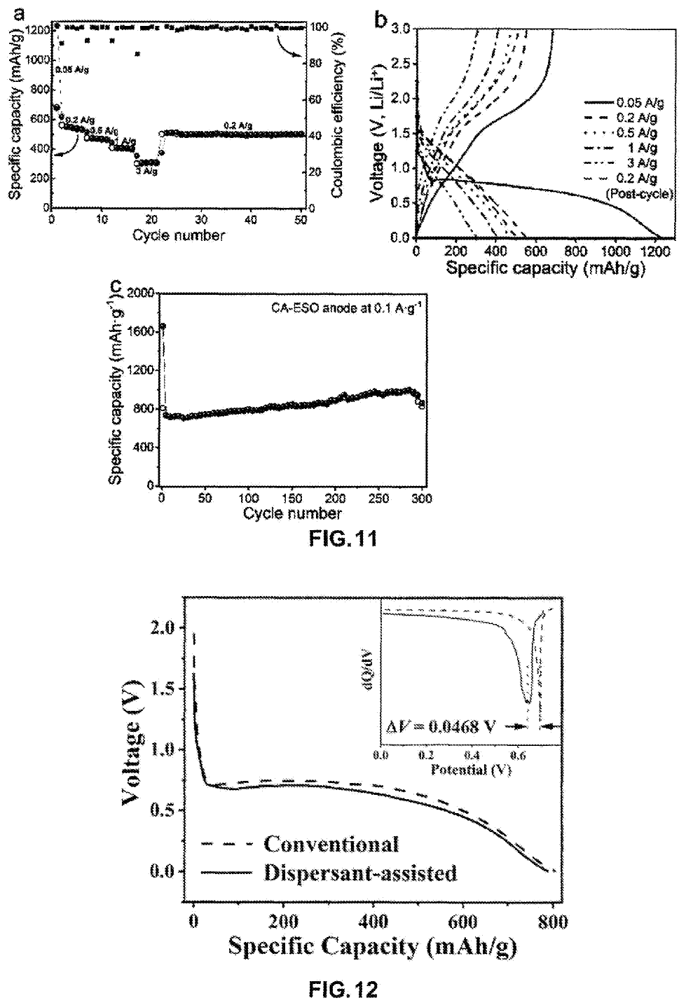

FIG. 9(c) exhibits the galvanostatic charge/discharge profiles of some representative cycles of the half-cell. The high-entropy oxide electrode delivers a relatively high discharge capacity of 1639 mAh·g⁻¹ at a current of 0.2 A·g−1 during the first cycle. The mechanism of lithium storage in high-entropy oxides is through conversion type reaction and, therefore, the initial Coulombic efficiency of the high-entropy oxide anode merely reaches 50.4%. The lithiation capacity then drops to 650 mAh·g⁻¹ at the 30^{th} cycle, before it increases to 1170 mAh·g⁻¹ at the 400^{th} cycle progressively. It is worth noting that the voltage profiles of 400^{th} and 470^{th} are nearly overlapped, indicating that the capacity of the high-entropy oxide anode is stabilised after 400 cycles. Likewise, FIG. 10 shows the impressive cyclability of the high-entropy oxide anode, demonstrating that the high-entropy oxide of the present invention is impressively stable. Furthermore, the high-entropy oxide anode displays excellent rate performance at increasing current rates and impressive capacity retention (FIG. 11 (a)). More specifically, the high-entropy oxide anode delivers high specific capacities of 545, 470, 407, and 308 mAh/g at 0.2, 0.5, 1, and 3 A/g, respectively. The capacity is stabilised at around 510 mAh/g in post cycles at 0.2 A/g, indicating superior structural stability of the high-entropy oxide anode under electrochemical operating conditions. FIG. 11 (b) demonstrates the charge/discharge profiles of the high-entropy oxide anode at different current rates. The discharge profile at 0.2 A·g⁻¹ after high-rate cycles is superimposed in FIG. 11 (b). It appears to be overlapped with a discharge profile at 0.2 A/g before high-rate cycles (black dashed line) from 1.5 to 1 V. Similarly, the discharge profiles in the same range display minor changes in capacity upon cycling in FIG. 9(c), implying that this conversion reaction process is highly reversible.

The electrochemical performance of high-entropy oxide materials prepared according to the present invention was compared with corresponding materials prepared using conventional annealing. The high-entropy oxide particles obtained after conventional annealing were also assembled into half-cells. FIG. 11 (c) displays the cycling performance of the conventionally annealed anode (CA-HEO) at a low current rate of 0.1 Å/g. Despite a low current rate, the CA-HEO anode exhibits a sudden capacity decay after 280 cycles. In addition, by comparing the first discharge profiles of both high-entropy oxide anodes, despite similar discharge capacities, the lithiation plateau observed in the high-entropy oxide rod anode was lower than that of the CA-HEO anode. There is a potential difference of around 46.8 mV between the plateaus of the two high-entropy oxide electrodes. Without wishing to be bound by theory, it is believed this lithiation potential difference may arise from the following two aspects. Firstly, the broad particle size distribution of CA-HEO may create uneven surface overpotentials and kinetics of lithiation/de-lithiation. Secondly, lithiation rates are dependent on the crystallographic directions. The high-entropy oxide rods synthesised in this study have an axial direction of <111>, and the sidewall planes of the rod are {110} and {112}. These non-closely packed planes are kinetically favourable for lithiation. Even though the fine size inevitably leads to a low initial Coulombic efficiency (that is, around 50%) caused by the enormous SEI formation, the short diffusion paths and stable 1D structure enable the high-entropy oxide rods anode a superior long-term cyclability and rate performance.

A comparison of the high-entropy oxide prepared according to the present invention with two known high-entropy oxide anodes is shown in Table 3. The high-entropy oxide anode according to the present invention delivers the most impressive electrochemical performance with the highest ratio of active material in anode. Furthermore, it is believed the low initial Coulombic efficiency can be effectively overcome by various pre-lithiation methods.

TABLE 3

| | High-entropy oxide anode | | |
|---|---|---|---|
| | Example 2 | Qiu et al. | Sarkar et al. |
| Materials | Mg_{0.2}Co_{0.2}Ni_{0.2}Cu_{0.2}Zn_{0.2}O | | |
| Structure | Rock salt | | |
| Synthesis | Co-precipitation | Solid-state | Nebulized Spray |
| method | according to the | synthesis | Pyrolysis |
| | present invention | | |
| Electrochemical | 1188 mAh/g at a | 920 mAh/g at a | 590 mAh/g at a |
| performance of | current rate at | current rate at | current rate at |
| active material | 0.2 A/g after 470 | 0.1 A/g after 300 | 0.2 A/g after 500 |
| (mAh/g) | cycles; 308 mAh/g | cycles; 490 mAh/g | cycles; about 160 |
| | at a current rate | at a current rate | mAh/g at a current |
| | at 3 A/g. | at 3 A/g. | rate at 3 A/g. |
| Proportion of | 80% | 70% | 63% |
| active material | | | |

### Example 4: Electrochemical Cell

A coin cell 1902 comprising a high-entropy oxide anode was constructed with the high-entropy oxide of Example 2. A schematic of the constructed coin cell 1902 is shown in FIG. 19. The coin cell 1902 included a top cap 1904, an anode 1906, a separator 1908, cathode foil 1910, a stainless steel spacer 1912, a wave spring 1914, and a bottom cap 1916. Anode 1906 comprised the (Mg_{0.2}Co_{0.2}Ni_{0.2}Cu_{0.2}Zn_{0.2})O high-entropy oxide, and was prepared according to the slurry method, described above in Example 3. The cathode foil 1910 comprised LiFePO₄ or LiNiCoMnO₂.

### Example 5: Co-Precipitation of an Oxalate Precursor of an (MgMnFeCoNi)O High-Entropy Oxide

An oxalate precursor of another high-entropy oxide ((MgMnFeCoNi)O, (Mg_{0.2}Mn_{0.2}Fe_{0.2}Co_{0.2}Ni_{0.2})O) was produced using a method similar to that of Example 1. However, some divalent cations involved (i.e., Fe²⁺ and Mn²⁺) are vulnerable to oxygen, as they are highly prone to be oxidized to their higher valence states. The fabrication of the precursor was therefore conducted in an inert atmosphere using a Schlenk line so that a pure Ar (Argon) environment could be used during the synthesis. A sample was made by first dissolving 0.1 mmol ascorbic acid (C₆H₈O₆) in a mixed solution of 15 ml deionized H₂O and 15 ml ethylene glycol. Ascorbic acid, which is a reducing agent, can effectively prevent the oxidation of Fe²⁺ and Mn²⁺ in the aqueous solution. Then, 1.1 mmol MgCl₂ (98%), 1 mmol MnCl₂·4H₂O (98%), 1 mmol FeCl₂ (98%), 1 mmol CoCl₂·6H₂O (99%), and 1 mmol NiCl₂·6H₂O (100%) were dissolved into the above solution in a round bottom flask. After all metal chlorides were added to the solution, the flask was swiftly connected to the Schlenk line and purged with argon gas three times. This solution of metal ions was warmed up to 50° C. under stirring. In another mixed solution of deionized H₂O and ethylene glycol (15 ml+15 ml), 5.1 mmol ammonium oxalate monohydrate (NH₄)₂C₂O₄·H₂O was dissolved at 50° C. The solution was then deoxygenated using the Schlenk line before injecting it into the solution of chlorides under vigorous stirring. After reacting for 6 hours at 50° C., the oxalate precursor was washed and separated via centrifugation a couple of times, followed by drying the precursor at 50° C. overnight.

FIG. 14 shows an SEM image of a rod-shaped particle of the oxalate precursor, (MgMnFeCoNi)C₂O₄.

### Example 6: Preparation of the (MgMnFeCoNi)O High-Entropy Oxide

The (MgMnFeCoNi)O high-entropy oxide as a single-phase solid solution was formed directly by calcining the oxalate precursor at a high temperature. The precursor was calcined using a tube furnace at 1000° C. for 5 h in an Ar atmosphere within a lidded corundum ceramic boat. The precursor was placed in a quartz pan within the boat, and MnO₂ as an oxygen generator was situated next to the quartz pan. The use of quartz pan allowed the MnO₂ to be situated close to the precursor sample, while preventing contact and contamination. The quantity of precursor powder was 300 mg, and the quantity of MnO₂ was 90 mg. Maintaining the temperature of 1000° C. for an extended duration of at least 5 hours was found to be an effective annealing process that resulted in a high-entropy oxide with good purity.

After formation, the high-entropy oxide was left to cool down naturally. The obtained dark brown powder was found to stable in room ambient conditions, as the phase purity showed no change after exposing the sample to air for several weeks.

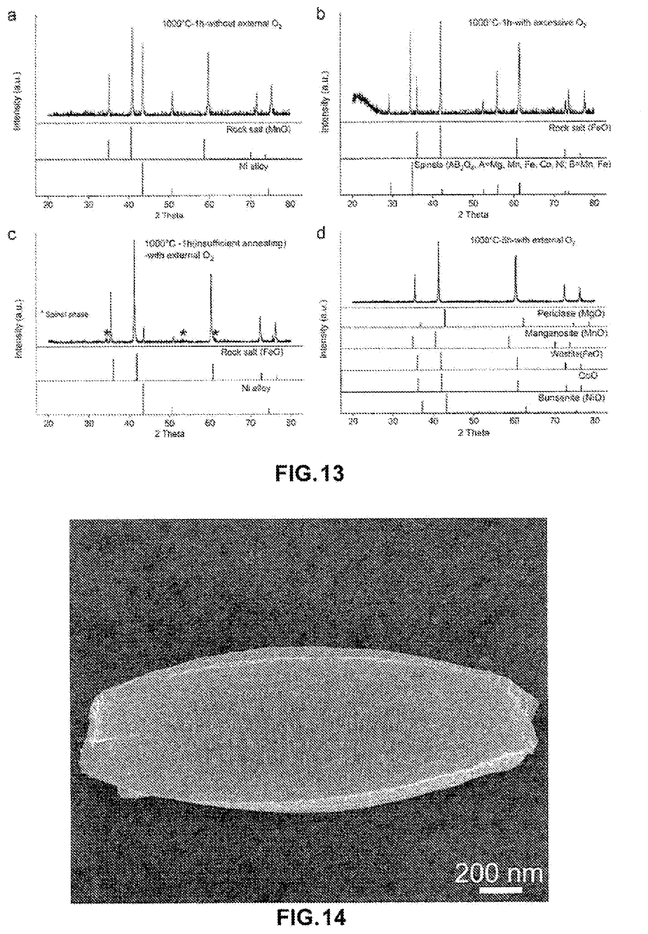

It was found that if the calcining and annealing process was performed in a pure Ar atmosphere, without any oxygen source, the resulting material included a mixture of wüstite (FeO) and Ni alloy (FIG. 13 (a)). The presence of the metallic phase can be ascribed to the generation of reductive by-products due to the decomposition of oxalate ligands (i.e., carbon and carbon monoxide) during the heat treatment.

MnO₂ was used in the calcining process as an oxygen generator to mitigate the effects of a reductive environment. MnO₂ decomposes progressively at high temperatures and releases a small amount of O₂, either neutralizing reductive substances or slightly oxidizing the as-formed metallic products. The lidded boat provided sufficient containment of to maintain the oxidative environment. MnO₂ undergoes a thermal decomposition as follows:

(400° C.˜800° C.) 2MnO₂=Mn₂O₃+½O₂

(Above 800° C.) Mn₂O₃=2Mn₃O₄+½O₂

FIG. 13 (b)-(d) shows the XRD patterns of samples formed with the addition of MnO₂ as an external oxygen source. An excess of oxygen from the decomposition of MnO₂ produces spinel products (AB₂O₄, A=Mg, Mn, Fe, Co, Ni; B═Fe, Mn) as shown in FIG. 13 (b). The spinel ferrites are formed because Fe²⁺ and Mn²⁺ ions are proportionally oxidized into Fe³⁺ and Mn³⁺ by extra oxygen generated from MnO₂ decomposition. A combination of trivalent Fe³⁺ and Mn³⁺ with remaining divalent cations (Mg²⁺, Mn²⁺, Fe²⁺, Co²⁺, and Ni²⁺) results in spinel products. These unwanted components can be avoided and/or minimised by utilising introducing into the annealing process an appropriate amount of oxygen. The amount can be readily determined by simple tests.

FIG. 13 (c) exhibits the co-existence of spinel and metallic phases in the oxide product that was calcined at 1000° C. with the controlled addition of MnO₂ and annealed by maintaining at 1000° C. for one hour. Due to a limited oxygen diffusion rate within the fixed bed, insufficient annealing resulted in an overoxidized top layer and an under-oxidized bottom layer. This problem was addressed by prolonging the annealing duration. As shown in FIG. 13 (d), compared with the product in FIG. 13 (c), when the calcined oxide was annealed by maintaining the same temperature with the same amount of MnO₂, the annealing time of 5 hours led to a well-crystallized single-phase solid solution having a rock salt crystal structure. Peak positions are shown in Table 4.

TABLE 4

| Peak | | | | | |
|---|---|---|---|---|---|
| positions | | | | | |
| 2θ | (111) | (200) | (220) | (311) | (222) |
| (MgMnFeCoNi)O | 35.5° | 41.3° | 60.3° | 72.5° | 76.3° |

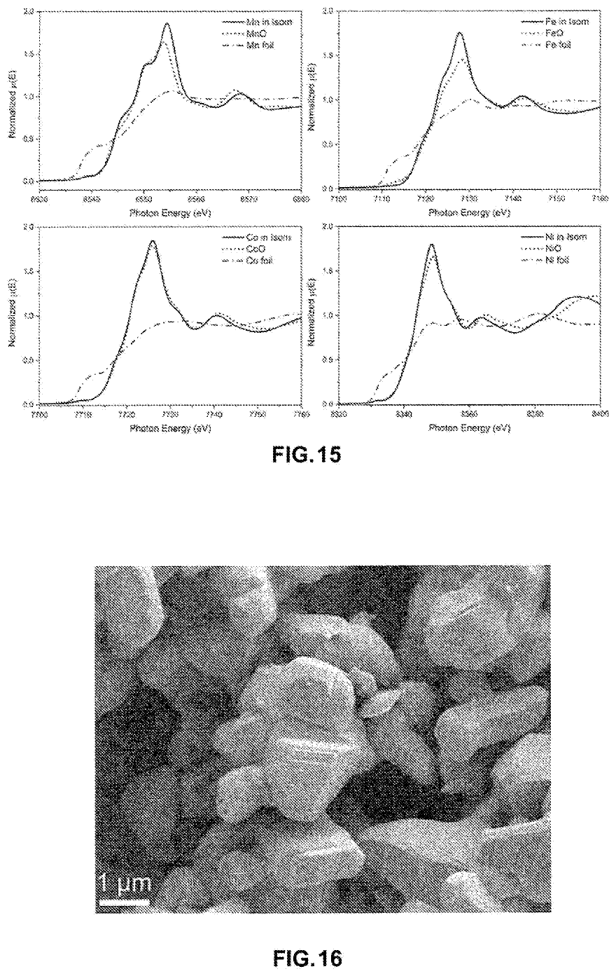

The oxidation states of each metal species were investigated by X-ray absorption near edge structure (XANES), and the results in FIG. 15 indicate that four transition metal elements unanimously have an average state close to +2. The slight increase in the pre-edge intensity for FeO reference material can be ascribed to the minor oxidization of octahedrally coordinated Fe²⁺ into Fe³⁺ with tetrahedral geometry.

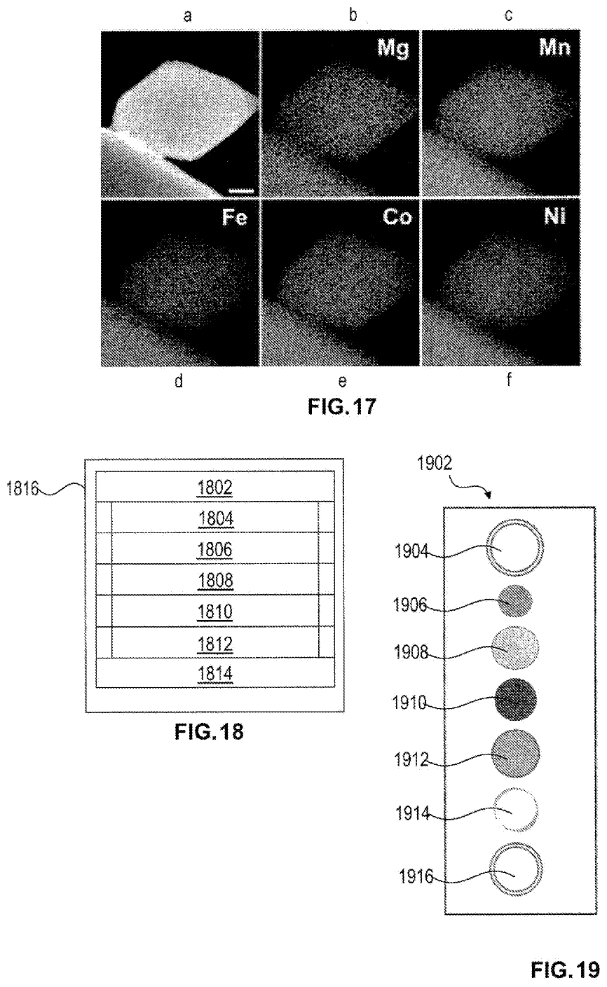

FIG. 16 shows an SEM image of the as-annealed high-entropy oxide material. The SEM shows rod-shaped particles and some agglomeration between particles. The use of a solid-state dispersant, such as those described herein, would reduce agglomeration. FIG. 17 (a) shows the dark-field scanning transmission electron microscopy (DF-STEM) analysis and FIG. 17 (b)-(f) show energy dispersive spectroscopy (EDS) mapping of the high-entropy oxide particles. A uniform distribution of different metal species can be clearly observed within the representative (MgMnFeCoNi)O particles.

It is not the intention to limit the scope of the invention to the abovementioned examples only. As would be appreciated by a skilled person in the art, many variations are possible without departing from the scope of the invention as set out in the accompanying claims.

What is claimed is:

1. A method of preparing a high-entropy oxide, the method comprising:
(a) mixing a solution comprising at least four elementally different metal cations in a solvent, each metal cation making up at least 5% of the total number of the four or more elementally different metal cations, with a precipitating agent to obtain a solid material comprising the at least four metal cations;
(b) thermally treating the solid material to obtain a high-entropy oxide;
wherein the precipitating agent comprises an organic anion.

2. The method of claim 1, wherein the thermal treatment includes a calcining process to produce a high-entropy oxide intermediate.

3. The method of claim 2, wherein the thermal treatment includes annealing the high-entropy oxide intermediate to obtain the high-entropy oxide.

4. The method of claim 3, wherein the high-entropy oxide intermediate is mixed with a solid-state dispersant before annealing.

5. The method of any one of claims 1 to 4, wherein the thermal treatment includes the use of a controlled atmosphere.

6. The method any one of claims 1 to 5, wherein the solution comprises at least five elementally different metal cations.

7. The method of any one of claims 1 to 6, wherein each metal cation is independently selected from the group consisting of cations of Be, Mg, Ca, Sr, Ba, Mn, Fe, Co, Ni, Cu, Zn, Gd, Pb and Pt.

8. The method of any one of claims 1 to 7, wherein the metal cations are independently selected from the group consisting of cations of Mg, Co, Ni, Cu and Zn.

9. The method of any one of claims 1 to 8, wherein the metal cations are independently selected from the group consisting of cations of Mg, Mn, Fe, Co and Ni.

10. The method of any one of claims 1 to 9, wherein the precipitating agent is an oxalate compound.

11. The method of any one of claims 1 to 10, wherein the solvent comprises water and ethylene glycol.

12. The method of claim 10 or 11 wherein the oxalate compound is ammonium oxalate.

13. A method of preparing a high-entropy oxide, the method comprising:
(a) mixing a solution comprising at least four elementally different metal cations in a solvent, each metal cation making up at least 5% of the total number of the four or more elementally different metal cations, with a precipitating agent to obtain a solid material comprising the at least four metal cations;
(b) thermally treating the solid material to obtain a high-entropy oxide intermediate;
(c) mixing the high-entropy oxide intermediate with a solid-state dispersant and annealing the high-entropy oxide intermediate to form the high-entropy oxide.

14. An oxalate salt comprising four or more elementally different metal cations, each metal cation making up at least 5% of the total number of metal cations.

15. The oxalate salt of claim 14, wherein each metal cation makes up between 5% and 30% of the total number of metal cations.

16. The oxalate salt of claim 14 or 15, in the form of particles comprising the four or more elementally different metal cations.

17. The oxalate salt of any one of claims 14 to 16, wherein each metal cation is independently selected from the group consisting of cations of Be, Mg, Ca, Sr, Ba, Mn, Fe, Co, Ni, Cu, Zn, Gd, Pb and Pt.

18. The oxalate salt of any one of claims 14 to 17, comprising a rod-like particle shape.

19. The oxalate salt of claim 18, wherein the length:width ratio of the particles is between about 1:1.5 to about 1:3.5.

20. The oxalate salt of any one of claims 14 to 19, represented by the formula (AᵥB_{w}CₓD_{y}E_{z})C₂O₄, wherein v, w, x, y and z are each independently about 0.05 to about 0.30, and wherein A, B, C, D, and E are each independently selected from the group consisting of cations of Be, Mg, Ca, Sr, Ba, Mn, Fe, Co, Ni, Cu, Zn, Gd, Pb and Pt.
